(19) United States
(12) Patent Application Publication
(10) Pub. No.: US 2009/0180434 A1
(43) Pub. Date: Jul. 16, 2009

(54) CENTRAL CONTROL APPARATUS, SIGNAL TRANSMISSION APPARATUS AND SIGNAL FORWARDING APPARATUS FOR USE IN A MULTI-HOP WIRELESS NETWORK

(75) Inventors: Shiann-Tsong Sheu, Taipei (TW); Yang-Han Lee, Zhongli City (TW); Yih-Guang Jan, Taipei City (TW); Kan-Chei Loa, Taipei (TW); Tsung-Yu Tsai, Shanhua Town (TW); Yi-Ting Lin, Yonghe City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/355,504

(22) Filed: Jan. 16, 2009

Related U.S. Application Data
(60) Provisional application No. 61/021,380, filed on Jan. 16, 2008.

(51) Int. Cl. H04W 74/00; H04L 12/28

(52) U.S. Cl. 370/329; 370/400

(57) ABSTRACT

The present invention provides a central control apparatus, a signal transmission apparatus and a signal forwarding apparatus for use in a multi-hop wireless network. The central control apparatus is configured to build a universal control (UC) channel between the central control apparatus, the signal transmission apparatus and the signal forwarding apparatus. Through the UC channel, the signal transmission apparatus may exchange control signals with the central control apparatus directly, so as to improve the transmission delay of the control signals.

This application claims the benefit of priority based on U.S. Ser. No. 61/021,380 filed on Jan. 16, 2008, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a central control apparatus, a signal transmission apparatus and a signal forwarding apparatus for use in a multi-hop wireless network. More specifically, the present invention relates to a central control apparatus, a signal transmission apparatus and a signal forwarding apparatus for use in a multi-hop wireless network based on an IEEE 802.16 standard.

2. Descriptions of the Related Art

Wireless networks based on an IEEE 802.16e/j standard have the following evident disadvantages: the overhead of uplink (UL) control signals and the delay of transmission of control messages. Therefore, an IEEE 802.16m standard is developed to overcome those disadvantages.

Wireless networks based on the IEEE 802.16m standard (“802.16m network” for short) or LTE-Advanced are able to support high speed mobility and broadband access. Furthermore, the 802.16m or LTE-Advanced network may deploy relay stations (RSs) in the network architecture. The 802.16m or LTE-Advanced network should encounter numerous crucial issues, such as frequent handover, multi-hop relaying, synchronization, and so on. Relaying control signals from a base station (BS) to a mobile station (MS) via RSs and vice versa can be done straightforwardly in the 802.16m or LTE-Advanced networks; however they may not be done efficiently.

To explain more clearly, please refer to FIG. 1, which is a schematic view of a conventional wireless network 1 based on the IEEE 802.16. The wireless network 1 comprises a base station (“BS” for short) 11, a relay station (“RS” for short) 13 and a mobile station (“MS” for short) 15. According to the definition of the IEEE 802.16 standard, when the BS 11 intends to transmit a control signal 110 to the MS 15, it must transmit the control signal 110 to the RS 13 first. After receiving the control signal 110, the RS 13 generally decodes, demodulates or amplifies the control signal 110 to generate a control signal 130 comprising the content of the control signal 110, and forwards the control signal 130 to the MS 15. After receiving the control signal 130, the MS 15 may do some actions according to the content of the control signal 110.

Similarly, when the MS 15 intends to transmit a control signal 150 to the BS 11, it also has to transmit the control signal 150 to the RS 13 first. After receiving the control signal 150, the RS 13 generally decodes, demodulates or amplifies the control signal 150 to generate a control signal 132 comprising the content of the control signal 150, and forwards the control signal 132 to the MS 15. After receiving the control signal 132, the BS 11 may do some actions according to the content of the control signal 150. In other words, the control signal transmissions between the BS 11 and the MS 15 in the wireless network 1 based on the IEEE 802.16 are performed by the RS 13. If there are two or more RSs located in the transmission path of the control signal, the control signal must be relayed by the whole RSs located in the transmission path so that the control signal transmission must be delayed even though the control signal needs to be transmitted in real-time.

In summary, how to transmit the control signals of the 802.16/multi-hop wireless network effectively is still an objective for the industry to endeavor.

### SUMMARY OF THE INVENTION

The primary objective of the present invention is to provide a central control apparatus for use in a multi-hop wireless network. The multi-hop wireless network includes at least one first station. The central control apparatus comprises a process module and a transceiver. The process module is configured to allocate a resource according to network resource information of the multi-hop wireless network and build a universal control (UC) channel between the central control apparatus and the at least one first station according to the allocated resource. The transceiver is configured to transmit a message about the UC channel to inform the at least one first station that the UC channel has been built so that the central control apparatus and the at least one first station may directly exchange at least one control signal through the UC channel, wherein each of the at least one first station may be considered as a signal transmission apparatus.

Another objective of the present invention is to provide a transmission method for use in the central control apparatus of the multi-hop wireless network. The multi-hop wireless network includes at least one first station. The central control apparatus stores network resource information of the multi-hop wireless network. The transmission method comprises the following steps of: allocating a resource according to the network resource information of the multi-hop wireless network; building a UC channel between the central control apparatus and the at least one first station according to the allocated resource; and transmitting a message about the UC channel to inform the least one first station that the UC channel has been built so that the central control apparatus and the at least one first station may directly exchange at least one control signal through the UC channel, wherein each of the at least one first station may he considered as a signal transmission apparatus.

Yet a further objective of the present invention is to provide a signal transmission apparatus for use in the multi-hop wireless network. The multi-hop wireless network includes a central control apparatus which is configured to build a UC channel between the signal transmission apparatus and the central control apparatus, and transmit a message about the UC channel. The signal transmission apparatus comprises a transceiver and a process module. The transceiver is configured to receive the message about the UC channel. The process module is configured to determine that the UC channel has been built between the signal transmission apparatus and the central control apparatus according to the message, and retrieve information, relating to the UC channel, from the message. The transceiver is further configured to directly exchange at least one control signal with the central control apparatus through the UC channel according to the information retrieved from the message.

Another objective of the present invention is to provide a transmission method for use in the signal transmission apparatus of the multi-hop wireless network. The multi-hop wireless network includes a central control apparatus. The central control apparatus is configured to build a UC channel between the signal transmission apparatus and the central control apparatus, and transmit a message about the UC channel. The transmission method comprises the following steps of: receiving the message about the UC channel; determining that the UC channel has been built between the signal transmission apparatus and the central control apparatus according to the message; retrieving information, relating to the UC channel, from the message; and exchanging at least one control signal with the central control apparatus through the UC channel according to the information retrieved from the message directly.

Yet a further objective of the present invention is to provide a signal forwarding apparatus for use in the multi-hop wireless network. The multi-hop wireless network includes a central control apparatus and a signal transmission apparatus. The central control apparatus is configured to build a UC channel between the central control apparatus, the signal transmission apparatus and the signal forwarding apparatus, and transmit a message about the UC channel. The signal transmission apparatus intends to transmit a first control signal to the central control apparatus. The signal forwarding apparatus comprises a transceiver and a process module. The transceiver is configured to receive the first control signal and the message about the UC channel. The process module is configured to determine that the UC channel has been built between the signal transmission apparatus and the central control apparatus according to the message, and retrieve information, relating to the UC channel, from the message. The transceiver is farther configured to transmit the first control signal to the central control apparatus through the UC channel according to the information retrieved from the message.

Another objective of the present invention is to provide a transmission method for use in the signal forwarding apparatus of the multi-hop wireless network. The multi-hop wireless network includes a central control apparatus and a signal transmission apparatus. The central control apparatus is configured to build a UC channel between the central control apparatus, the signal transmission apparatus and the signal forwarding apparatus, and transmit a message about the UC channel. The signal transmission apparatus intends to transmit a first control signal to the central control apparatus. The transmission method comprises the following steps of: receiving the first control signal; receiving the message about the UC channel; determining that the UC channel has been built between the signal transmission apparatus and the central control apparatus according to the message; retrieving information, relating to the UC channel, from the message; and transmitting the first control signal to the central control apparatus through the UC channel according to the information retrieved from the message.

According to the aforementioned descriptions, the present invention provides a UC channel built by the central control apparatus (may be a BS, an ASN gateway of the IEEE 802.16 standard) in the multi-hop wireless network. Through the UC channel, the signal transmission apparatus (may be an MS of the IEEE 802.16 standard), the signal forwarding apparatus (may be an RS of the IEEE 802.16 standard) and the central control apparatus may exchange the control signals with each others directly. Furthermore, the signal transmission apparatus may exchange the control signals with the central control apparatus via the signal forwarding apparatus through the UC channel. In other words, through the UC channel, the disadvantages of the conventional multi-hop wireless network can be overcome and the advantages thereof are also maintained.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional wireless network;

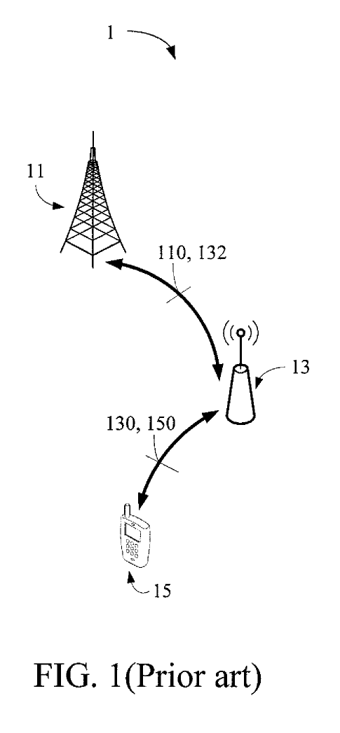

FIG. 2 is a schematic view of a multi-hop wireless network of a first embodiment of the present invention;

FIG. 3 is a schematic view of a central control apparatus of the first embodiment;

FIG. 4 is a schematic view of a signal forwarding apparatus of the first embodiment;

FIG. 5 is a schematic view of a signal transmission apparatus of the first embodiment;

FIG. 6 is a schematic view of a frame structure of the first embodiment;

FIG. 7 is a schematic view of another frame structure of the first embodiment;

FIG. 8 is a schematic view of the UC channel carrying traffic indication signal;

FIG. 9 is a schematic view of a multi-hop wireless network of a second embodiment of the present invention;

FIG. 10 is a schematic view of a multi-hop wireless network of a third embodiment of the present invention;

FIG. 11 is a flow chart of a fourth embodiment of the present invention;

FIG. 12 is a flow chart of a fifth embodiment of the present invention;

FIG. 13A is a first flow chart of a sixth embodiment of the present invention;

FIG. 13B is a second flow chart of the sixth embodiment of the present invention; and

FIG. 13C is a third flow chart of the sixth embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, descriptions of these embodiments are only intended to illustrate rather than to limit the present invention. It should be appreciated that, in the following embodiments and the attached drawings, elements not related directly to the present invention are omitted from illustration; and dimensional relationships among individual elements in the attached drawings are illustrated only for ease of understanding, but not to limit the actual scale.

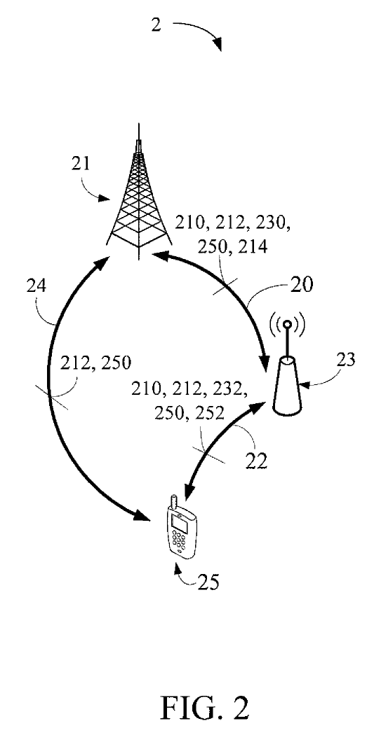

A first preferred embodiment of the present invention is illustrated in FIG. 2, which is a schematic view of a multi-hop wireless network 2 including a central control apparatus 21, a signal forwarding apparatus 23 and a signal transmission apparatus 25. It should be noted that, in principle, the central control apparatus 21 may be considered as a BS or an ASN gateway with an ability to build a universal control (UC) channel, the signal forwarding apparatus 23 may be considered as a relay station compatible with the UC channel, the signal transmission apparatus 25 may be considered as a mobile station compatible with the UC channel. The multi-hop wireless network 2 conforms to the IEEE 802.16 standard, the LTE-Advanced standard or any wireless network standards with the ability of the multi-hop.

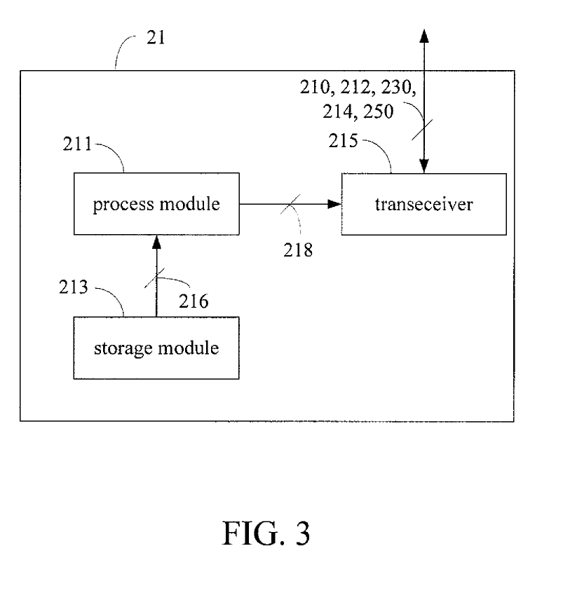

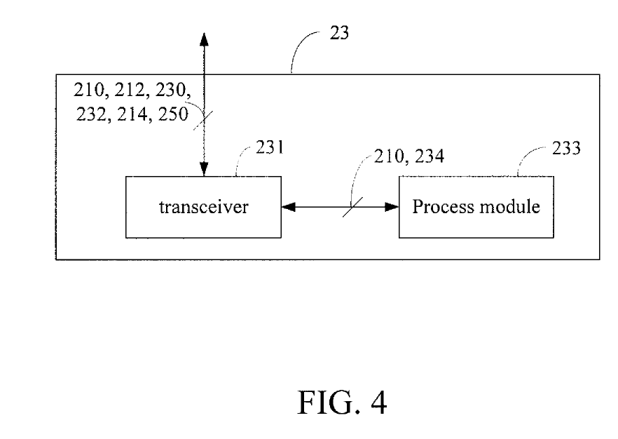

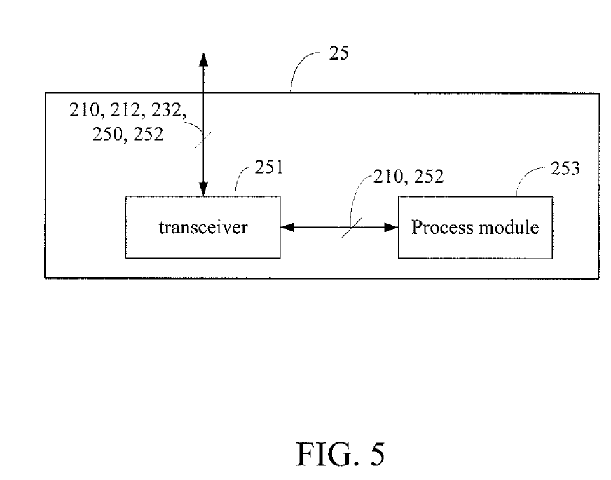

The constructions of the central control apparatus 21, the signal forwarding apparatus 23 and the signal transmission apparatus 25 will be roughly introduced in FIG. 3, FIG. 4 and FIG. 5, respectively first. FIG. 3 is a schematic view of the central control apparatus 21 comprising a process module 211, a storage module 213 and a transceiver 215. FIG. 4 is a schematic view of the signal forwarding apparatus 23 comprising a transceiver 231 and a process module 233. FIG. 5 is a schematic view of the signal transmission apparatus 25 comprising a transceiver 251 and a process module 253. The detailed operations and functions of the modules and the transceivers in the central control apparatus 21, the signal forwarding apparatus 23 and the signal transmission apparatus 25 will be described further in the following paragraphs.

Please refer to FIG. 2 and FIG. 3 together. The storage module 213 of the central control apparatus 21 is configured to store network resource information 216 of the multi-hop wireless network 2. The network resource information 216 is stored to record the status of the network resource, such as occupied bandwidth, current quality of service and so on. According to the network resource information 216 stored in the storage module 213, the process module 211 of the central control apparatus 21 is configured to allocate a resource to build a UC channel between the central control apparatus 21, the signal forwarding apparatus 23 and the signal transmission apparatus 25. After allocating the resource, the process module 211 of the central control apparatus 21 is configured to update the network resource information 216 stored in the storage module 213.

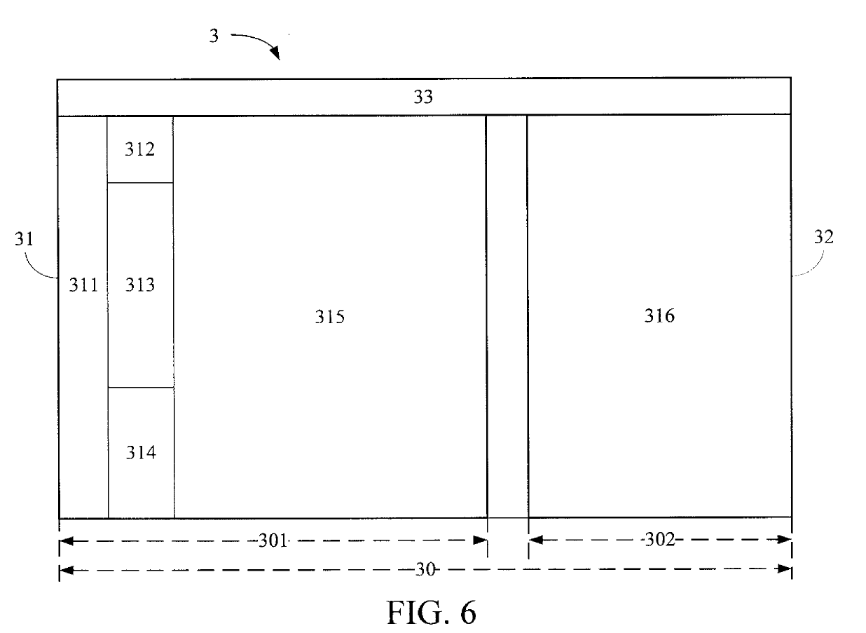

Basically, the UC channel can be presented by a frame structure. Please refer to FIG. 6, which is a schematic view of a frame structure 3 comprising the UC channel 33 in time-division (TDD) mode. In FIG. 6, the horizontal axis indicates time and the vertical axis indicates frequency. The frame structure 3 is designed with a frame duration 30. The frame duration 30 comprises a downlink frame duration 301 and an uplink frame duration 302. The frame structure 3 comprises a downlink frame 31, an uplink frame 32, and a UC channel 33. The downlink frame 31 is with the downlink frame duration 301, while the uplink frame 32 is with the uplink frame duration 302. The UC channel 33 is with the frame duration 30, that is, the frame structure 3 has the UC channel in the TDD mode. In addition, the downlink frame 31 comprises a preamble 311, an FCH 312, a DL-MAP 313, a UL-MAP 314, an 802.16m DL 315, and the uplink frame 32 comprises an 802.16m UL 316.

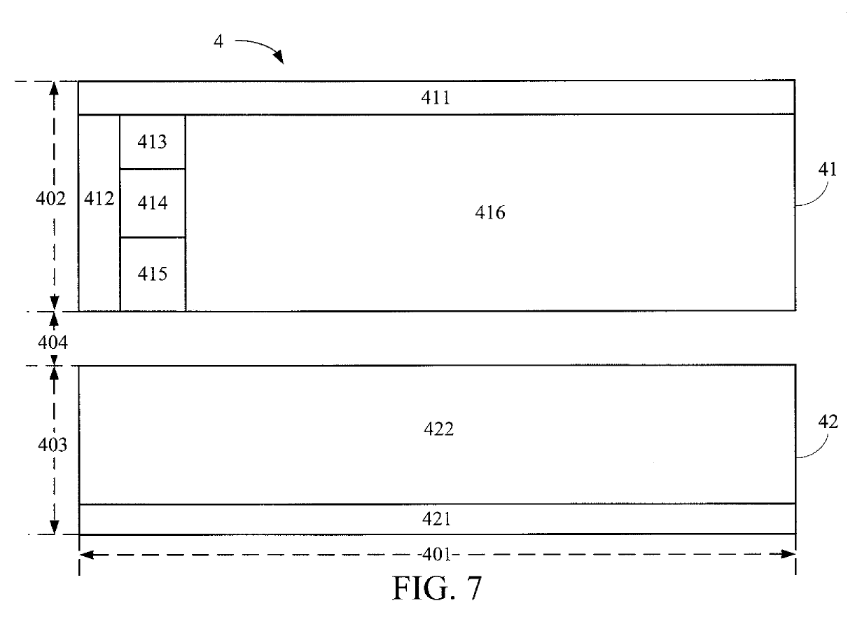

Please refer to FIG. 7, which is a schematic view of a frame structure 4 comprising the UC channel in frequency-division (FDD) mode. In FIG. 7, the horizontal axis indicates time and the vertical axis indicates frequency. The frame structure 4 is designed with a frame duration 401 and is allocated with frequency ranges 402, 403, 404. The frame structure 4 comprises a downlink frame 41 and an uplink frame 42. The downlink frame 41 corresponds to frequency range 402 and is with frame duration 401, while the uplink frame 42 corresponds to frequency range 403 and is with frame duration 401. The frequency range 404 is the guard band between the downlink frame 41 and the uplink frame 42. The frame structure 4 comprises a UC channel in the FDD mode. To be more specific, the UC channel comprises a downlink UC channel 411 in the downlink frame 41 and an uplink UC channel 421 in the uplink frame 42. In addition, the downlink frame 41 further comprises a preamble 412, an FCH 413, a DL-MAP 414, a UL-MAP 415, and an 802.16m DL, 416. The uplink frame 42 further comprises an 802.16m UL 422. It should be noted that the aforementioned two frame structures are just as examples, and are not described to limit the present invention.

After building the UC channel, the process module 211 of the central control apparatus 21 generates an enable signal 218 to the transceiver 215. The transceiver 215 is configured to transmit a message 210 about the UC channel to inform the signal forwarding apparatus 23 and the signal transmission apparatus 25 that the UC channel has been built so that the central control apparatus 21, the signal forwarding apparatus 23 and the signal transmission apparatus 25 may directly exchange at least one control signal through the UC channel.

Please refer to FIG, 4 and FIG. 5. The transceiver 231 of the signal forwarding apparatus 23 is configured to receive the message 210 about the UC channel. The process module 233 of the signal forwarding apparatus 23 is configure to determine that the UC channel has been built between the signal transmission apparatus 25, the signal forwarding apparatus 23 and the central control apparatus 21 according to the message, and retrieve information 234, relating to the UC channel, from the message 210. After that, the transceiver 231 of the signal forwarding apparatus 23 may exchange at least one control signal with the central control apparatus 21 and the signal transmission apparatus 25 according to the information 234 retrieved from the message 210.

Similarly, the transceiver 251 of the signal transmission apparatus 25 is configured to receive the message 210 about the UC channel. The process module 253 of the signal transmission apparatus 25 is configure to determine that the UC channel has been built between the signal transmission apparatus 25, the signal forwarding apparatus 23 and the central control apparatus 21 according to the message 210, and retrieve information 252, relating to the UC channel, from the message 210. After that, the transceiver 251 of the signal transmission apparatus 25 may exchange at least one control signal with the central control apparatus 21 and the signal forwarding apparatus 23 according to the information 252 retrieved from the message 210.

Particularly, when the signal transmission apparatus 25 intends to transmit a first control signal 250 to the central control apparatus 21, as shown in FIG. 2, the transceiver 251 of the signal transmission apparatus 25 can transmit the first control signal 250 to the central control apparatus 21 directly through the UC channel. In this case, transmission delay of the first control signal 250 can be reduced effectively.

In another case, the transceiver 251 of the signal transmission apparatus 25 can transmit the first control signal 250 to the central control apparatus 21 via the signal forwarding apparatus 23 through the UC channel. Transmission delay of the first control signal 250 also can be reduced effectively because the signal forwarding apparatus 23 can forward the first control signal 250 to the central control apparatus 21 directly. In particular, the transceiver 231 of the signal forwarding apparatus 23 is configured to receive the first control signal 250, and transmit the first control signal 250 to the central control apparatus 21 through the UC channel according to the information 234 retrieved from the message 210.

When the central control apparatus 21 intends to transmit a second control signal 212 to the signal transmission apparatus 25, as shown in FIG. 2, the transceiver 215 of the central control apparatus 21 can transmit the second control signal 212 to the signal transmission apparatus 25 directly through the UC channel. In this case, transmission delay of the second control signal 212 can be reduced effectively.

In another case, the transceiver 215 of the central control apparatus 21 can transmit the second control signal 212 to the signal transmission apparatus 25 via the signal forwarding apparatus 23 through the UC channel. Transmission delay of the second control signal 212 also can be reduced effectively because the signal forwarding apparatus 23 can forward the second control signal 212 to the signal transmission apparatus 25 directly. In particular, the transceiver 231 of the signal forwarding apparatus 23 is configured to receive the second control signal 212, and transmit the second control signal 212 to the signal transmission apparatus 25 through the UC channel according to the information 234 retrieved from the message 210.

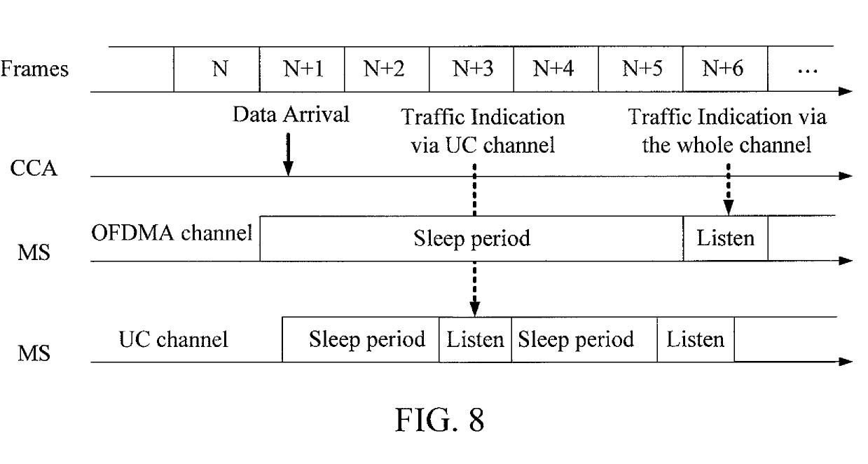

To manifest the effect of the UL channel, please refer to FIG. 8, which is a schematic view of the UC channel carrying traffic indication signals. It should be noted that the traffic indication signal is a kind of control signal. In FIG. 8, N indicates Nth frame, CCA indicates the central control apparatus and MS indicates the mobile station. In the 802.16e network, the delay of CCA waking up an MS for data reception is determined by the sleep interval at that time. If the power consumption of accessing UC channel is lower than that in accessing the whole channel, the scheduled sleep periods on UC channel could be shorter. The efficiency of process that CCA wakes up MS via broadcasting traffic indication signals is improved.

In addition, the signal forwarding apparatus 23 also can exchange the control signals with the central control apparatus 21 or the signal transmission apparatus 25 through the UC channel. In FIG. 2, the signal forwarding apparatus 23 can transmit a third control signal 230 to the central control apparatus 21 through the UC channel, and, according to the third control signal 230, the central control apparatus 21 will transmit a control signal 214 to the signal forwarding apparatus 23 through the UC channel. On the other hand, the signal forwarding apparatus 23 can transmit a fourth control signal 232 to the signal transmission apparatus 25 through the UC channel, and, according to the fourth control signal 232, the signal transmission apparatus 25 will transmit a control signal 252 to the signal forwarding apparatus 23 through the UC channel.

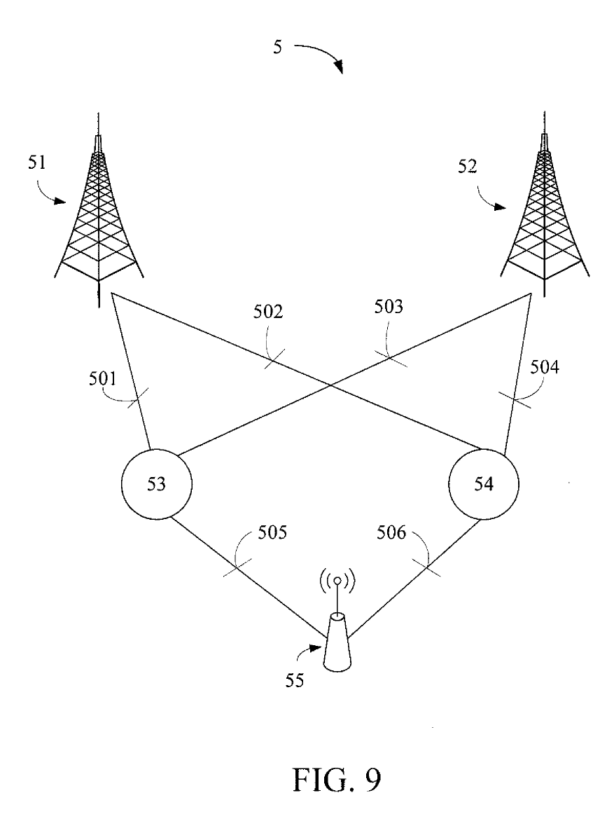

A second preferred embodiment of the present invention is illustrated in FIG. 9, which is a schematic view of a multi-hop wireless network 5 using the UC channel to carry handover signals. Each of the handover signals is a control signal. The multi-hop wireless network 5 includes two central control apparatuses 51, 52, a signal transmission apparatus (not shown), and a signal forwarding apparatus 55. The functions of the central control apparatuses 51, 52, the signal transmission apparatus and signal forwarding apparatus 55 are similar to those of the central control apparatus, the signal transmission apparatus and signal forwarding apparatus in the first preferred embodiment, and not described again. The multi-hop wireless network 5 conforms to the IEEE 802.16 standard, the LTE-Advanced standard or any wireless network standards with the ability of the multi-hop.

The signal transmission apparatus moves from a location 53 to another location 54. The UC channels 501, 502, 503, 504, 505, 506 exist in the multi-hop wireless network 5. The central control apparatuses 51, 52 and the signal forwarding apparatus 55 can listen to the handover signals transmitted through the UC channels 501, 502, 503, 504, 505, 506, and cooperate in process of fast handover or route switching between signal transmission apparatus and the central control apparatuses 51, 52.

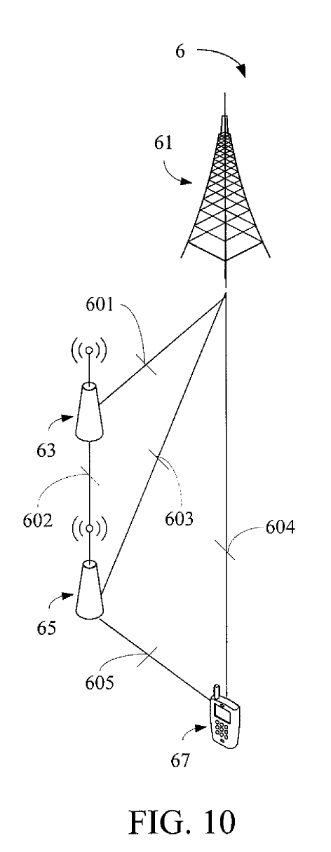

A third preferred embodiment of the present invention is illustrated in FIG. 10, which is a schematic view of a multi-hop wireless network 6. The multi-hop wireless network 6 includes a central control apparatus 61, a signal transmission apparatus 67, and two signal forwarding apparatus 63, 65. The functions of the central control apparatuses 61, the signal transmission apparatus 67 and signal forwarding apparatuses 63, 65 are similar to those of the central control apparatus, the signal transmission apparatus and signal forwarding apparatus in the first preferred embodiment, and not described again. The multi-hop wireless network 6 conforms to the IEEE 802.16 standard, the LTE-Advanced standard or any wireless network standards with the ability of the multi-hop.

The multi-hop wireless network 6 has the UC channel channels 601, 602, 603, 604, 605 which are built by the central control apparatus 61. The central control apparatus 61, the signal transmission apparatus 67, and the signal forwarding apparatus 63, 65 can listen to the control signals transmitted through the UC channels 601, 602, 603, 604, 605. In other words, the transmission apparatus 67 may transmit a control signal to the central control apparatus 61 through any combination of the UC channels 601, 602, 603, 604, 605.

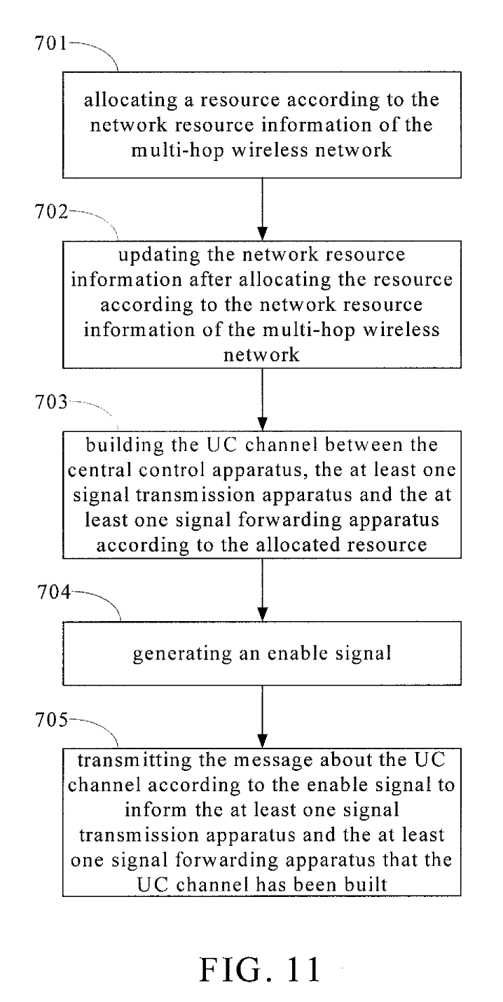

A fourth preferred embodiment of the present invention is illustrated in FIG. 11, which is a flow chart of a transmission method adapted to be used in the central control apparatuses of the multi-hop wireless network in the aforementioned embodiments. The multi-hop wireless network includes at least one signal transmission apparatus and at least one signal forwarding apparatus. The central control apparatus stores network resource information of the multi-hop wireless network. The transmission method of this embodiment comprises the following steps. Step 701 is executed to allocate a resource according to the network resource information of the multi-hop wireless network. Step 702 is executed to update the network resource information after allocating the resource according to the network resource information of the multi-hop wireless network.

Step 703 is executed to build the UC channel between the central control apparatus, the at least one signal transmission apparatus and the at least one signal forwarding apparatus according to the allocated resource. Step 704 is executed to generate an enable signal. Finally, Step 705 is executed to transmit the message about the UC channel according to the enable signal to inform the least one signal transmission apparatus and the at least one signal forwarding apparatus that the UC channel has been built so that the at least one signal transmission apparatus may exchange the at least one control signal with the central control apparatus via the at least one signal forwarding apparatus through the UC channel.

In addition to the steps shown in FIG. 11, this embodiment can also execute all the operations and functions of the above embodiments. Those of ordinary skill in the art will readily know how to execute the corresponding operations and functions in this embodiment by referring to those in the above embodiment; therefore, a detailed description will be omitted here.

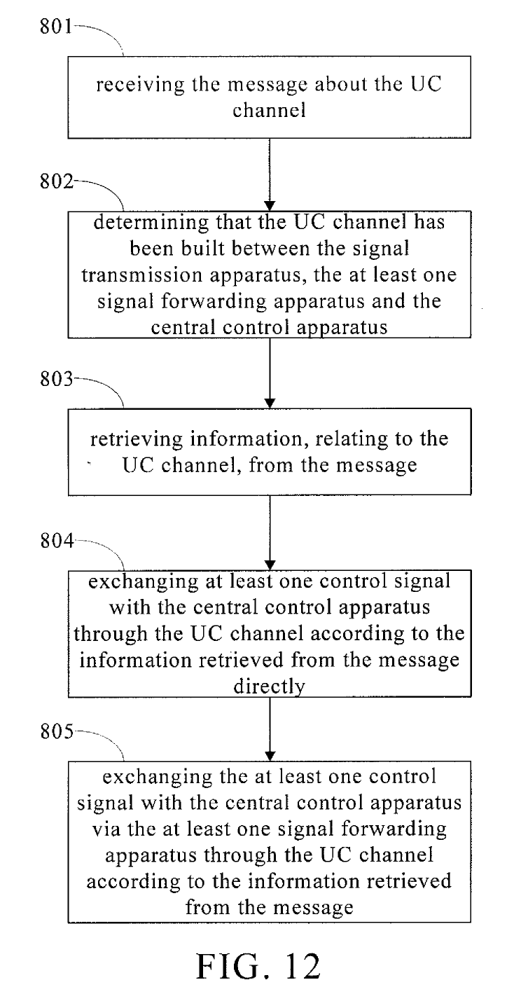

A fifth preferred embodiment of the present invention is illustrated in FIG. 12, which is a flow chart of a transmission method adapted to be used in the signal transmission apparatuses of the multi-hop wireless network in the aforementioned embodiments. The transmission method of this embodiment comprises the following steps. The multi-hop wireless network includes a central control apparatus and at least one signal forwarding apparatus. The central control apparatus is configured to build a UC channel between the signal transmission apparatus, the at least one signal forwarding apparatus and the central control apparatus, and transmit a message about the UC channel. Step 801 is executed to receive a message about the UC channel. Step 802 is executed to determine that the UC channel has been built between the signal transmission apparatus, the at least one signal forwarding apparatus and the central control apparatus.

Step 803 is executed to retrieve information, relating to the UC channel, from the message. Step 804 is executed to exchange at least one control signal with the central control apparatus through the UC channel according to the information retrieved from the message directly. Step 805 is executed to exchange the at least one control signal with the central control apparatus via the at least one signal forwarding apparatus through the UC channel according to the information retrieved from the message.

In addition to the steps shown in FIG. 12, this embodiment can also execute all the operations and functions of the above embodiments. Those of ordinary skill in the art will readily know how to execute the corresponding operations and functions in this embodiment by referring to those in the above embodiment; therefore, a detailed description will be omitted here.

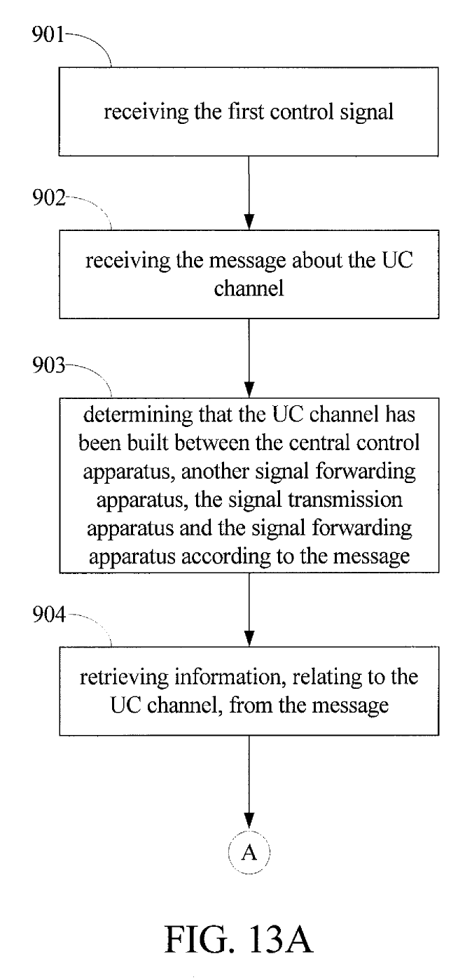

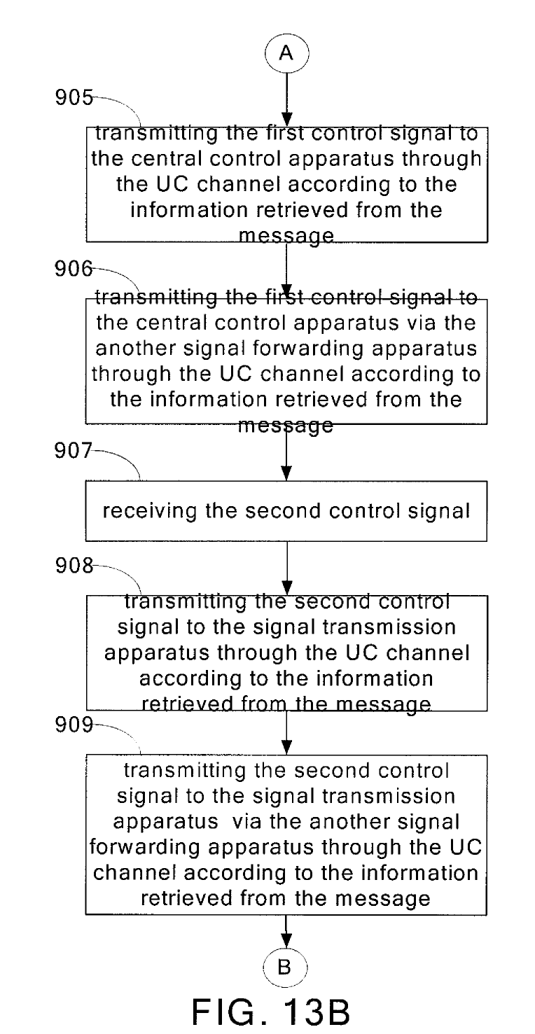

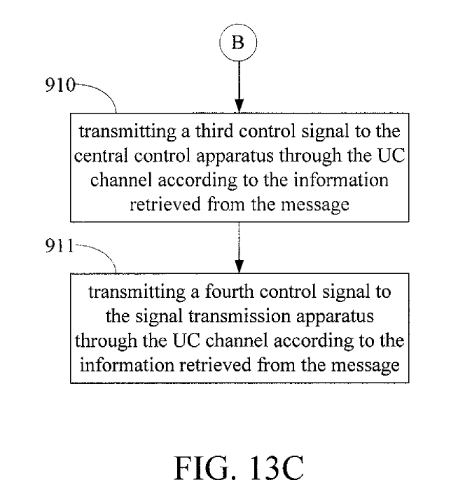

A sixth preferred embodiment of the present invention is illustrated in FIGS. 13A-13C, which are the flow charts of a transmission method adapted to be used in the signal forwarding apparatuses of the multi-hop wireless network in the aforementioned embodiments. The multi-hop wireless network includes a central control apparatus, another signal forwarding apparatus and a signal transmission apparatus. The central control apparatus is configured to build a UC channel between the central control apparatus, the signal forwarding apparatus, the signal transmission apparatus and another signal forwarding apparatus, and transmit a message about the UC channel. The signal transmission apparatus intends to transmit a first control signal to the central control apparatus. The central control apparatus intends to transmit a second control signal to the signal transmission apparatus.

The transmission method of this embodiment comprises the following steps. Step 901 is executed to receive the first control signal. Step 902 is executed to receive the message about the UC channel. Step 903 is executed to determine that the UC channel has been built between the central control apparatus, the signal forwarding apparatus, the signal transmission apparatus and another signal forwarding apparatus according to the message. Step 904 is executed to retrieve information, relating to the UC channel, from the message. Step 905 is executed to transmit the first control signal to the central control apparatus through the UC channel according to the information retrieved from the message.

Step 906 is executed to transmit the first control signal to the central control apparatus via the another signal forwarding apparatus through the UC channel according to the information retrieved from the message. Step 907 is executed to receive the second control signal. Step 908 is executed to transmit the second control signal to the signal transmission apparatus through the UC channel according to the information retrieved from the message. Step 909 is executed to transmit the second control signal to the signal transmission apparatus via the another signal forwarding apparatus through the UC channel according to the information retrieved from the message. Step 910 is executed to transmit a third control signal to the central control apparatus through the UC channel according to the information retrieved from the message. Step 911 is executed to transmit a fourth control signal to the signal transmission apparatus through the UC channel according to the information retrieved from the message.

In addition to the steps shown in FIGS. 13A-13C, this embodiment can also execute all the operations and functions of the above embodiments. Those of ordinary skill in the art will readily know how to execute the corresponding operations and functions in this embodiment by referring to those in the above embodiment; therefore, a detailed description will be omitted here.

According to the aforementioned descriptions, the present invention provides a UC channel built by the central control apparatus (may be a BS, an ASN gateway of the IEEE 802.16 standard) in the multi-hop wireless network. Through the UC channel, the signal transmission apparatus (may be an MS of the IEEE 802.16 standard) and the signal forwarding apparatus (may be an RS of the IEEE 802.16 standard), and the central control apparatus may exchange the control signals with each others directly. Furthermore, the signal transmission apparatus may exchange the control signals with the central control apparatus via the signal forwarding apparatus through the UC channel. In other words, through the UC channel, the disadvantages of the conventional multi-hop wireless network can be overcome and the advantages thereof are also maintained.

The above disclosure is related to the detailed technical contents and inventive features thereof. People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A central control apparatus for use in a multi-hop wireless network, the multi-hop wireless network including at least one signal transmission apparatus, the central control apparatus comprising:
a process module, being configured to allocate a resource according to network resource information of the multi-hop wireless network, build a universal control (UC) channel between the central control apparatus and the at least one signal transmission apparatus according to the allocated resource, and generate an enable signal; and
a transceiver, being configured to transmit a message about the UC channel according to the enable signal to inform the least one signal transmission apparatus that the UC channel has been built so that the central control apparatus and the at least one signal transmission apparatus may directly exchange at least one control signal through the UC channel.

2. The central control apparatus as claimed in claim 1, further comprising a storage module being configured to store the network resource information of the multi-hop wireless network.

3. The central control apparatus as claimed in claim 1, wherein the process module is further configured to update the network resource information of the storage module after allocating the resource according to the network resource information of the multi-hop wireless network.

4. The central control apparatus as claimed in claim 1, wherein the multi-hop wireless network further includes at least one signal forwarding apparatus, the process module is configured to build the UC channel between the central control apparatus, the at least one signal transmission apparatus and the at least one signal forwarding apparatus according to the allocated resource.

5. The central control apparatus as claimed in claim 4, wherein the transceiver is further configured to transmit the message about the UC channel according to the enable signal to inform the at least one signal transmission apparatus and the at least one signal forwarding apparatus that the UC channel has been built so that the at least one signal transmission apparatus may exchange the at least one control signal with the central control apparatus via the at least one signal forwarding apparatus through the UC channel.

6. A transmission method for use in a central control apparatus of a multi-hop wireless network, the multi-hop wireless network including at least one signal transmission apparatus, the central control apparatus storing network resource information of the multi-hop wireless network, the transmission method comprising the following steps of:
allocating a resource according to the network resource information of the multi-hop wireless network;
building a UC channel between the central control apparatus and the at least one signal transmission apparatus according to the allocated resource;
generating an enable signal; and
transmitting a message about the UC channel according to the enable signal to inform the at least one signal transmission apparatus that the UC channel has been built so that the central control apparatus and the at least one signal transmission apparatus may directly exchange at least one control signal through the UC channel.

7. The transmission method as claimed in claim 6, further comprising a step of updating the network resource information after allocating the resource according to the network resource information of the multi-hop wireless network.

8. The transmission method as claimed in claim 6, wherein the multi-hop wireless network further includes at least one signal forwarding apparatus, the building step is a step of building the UC channel between the central control apparatus, the at least one signal transmission apparatus and the at least one signal forwarding apparatus according to the allocated resource.

9. The transmission method as claimed in claim 8, wherein the transmitting step is a step of transmitting the message about the UC channel according to the enable signal to inform the at least one signal transmission apparatus and the at least one signal forwarding apparatus that the UC channel has been built so that the at least one signal transmission apparatus may exchange the at least one control signal with the central control apparatus via the at least one signal forwarding apparatus through the UC channel.

10. A signal transmission apparatus for use in a multi-hop wireless network, the multi-hop wireless network including a central control apparatus, the central control apparatus being configured to build a UC channel between the signal transmission apparatus and the central control apparatus, and transmit a message about the UC channel, the signal transmission apparatus comprising:
a transceiver, being configured to receive the message about the UC channel; and
a process module, being configured to determine that the UC channel has been built between the signal transmission apparatus and the central control apparatus according to the message, and retrieve information, relating to the UC channel, from the message;
wherein the transceiver is further configured to directly exchange at least one control signal with the central control apparatus through the UC channel according to the information retrieved from the message.

11. The signal transmission apparatus as claimed in claim 10, wherein the multi-hop wireless network further includes at least one signal forwarding apparatus, the central control apparatus is configured to build the UC channel between the signal transmission apparatus, the at least one signal forwarding apparatus and the central control apparatus, the transceiver is further configured to exchange the at least one control signal with the central control apparatus via the at least one signal forwarding apparatus through the UC channel according to the information retrieved from the message.

12. A transmission method for use in a signal transmission apparatus of a multi-hop wireless network, the multi-hop wireless network including a central control apparatus, the central control apparatus being configured to build a UC channel between the signal transmission apparatus and the central control apparatus, and transmit a message about the UC channel, the transmission method comprising the following steps of:
receiving the message about the UC channel;
determining that the UC channel has been built between the signal transmission apparatus and the central control apparatus according to the message;
retrieving information, relating to the UC channel, from the message; and
exchanging at least one control signal with the central control apparatus through the UC channel according to the information retrieved from the message directly.

13. The transmission method as claimed in claim 12, wherein the multi-hop wireless network further includes at least one signal forwarding apparatus, the central control apparatus is configured to build the UC channel between the signal transmission apparatus, the at least one signal forwarding apparatus and the central control apparatus, the exchanging step is a step of exchanging the at least one control signal with the central control apparatus via the at least one signal forwarding apparatus through the UC channel according to the information retrieved from the message.

14. A signal forwarding apparatus for use in a multi-hop wireless network, the multi-hop wireless network including a central control apparatus and a signal transmission apparatus, the central control apparatus being configured to build a UC channel between the central control apparatus, the signal transmission apparatus and the signal forwarding apparatus, and transmit a message about the UC channel, the signal transmission apparatus intending to transmit a first control signal to the central control apparatus, the signal forwarding apparatus comprising:
a transceiver, being configured to receive the first control signal and the message about the UC channel; and
a process module, being configured to determine that the UC channel has been built between the signal transmission apparatus, the signal forwarding apparatus and the central control apparatus according to the message, and retrieve information, relating to the UC channel, from the message;
wherein the transceiver is further configured to transmit the first control signal to the central control apparatus through the UC channel according to the information retrieved from the message.

15. The signal forwarding apparatus as claimed in claim 14, wherein the multi-hop wireless network includes another signal forwarding apparatus, the transceiver is further configured to transmit the first control signal to the central control apparatus via the another signal forwarding apparatus through the UC channel according to the information retrieved from the message.

16. The signal forwarding apparatus as claimed in claim 14, wherein when the central control apparatus intends to transmit a second control signal to the signal transmission apparatus, the transceiver is further configure to receive the second control signal and transmit the second control signal to the signal transmission apparatus through the UC channel according to the information retrieved from the message.

17. The signal forwarding apparatus as claimed in claim 16, wherein the multi-hop wireless network includes another signal forwarding apparatus, the transceiver is further configure to transmit the second control signal to the signal transmission apparatus via the another signal forwarding apparatus through the UC channel according to the information retrieved from the message.

18. The signal forwarding apparatus as claimed in claim 14, wherein the transceiver is further configured to transmit a third control signal to the central control apparatus through the UC channel according to the information retrieved from the message.

19. The signal forwarding apparatus as claimed in claim 14, wherein the transceiver is further configured to transmit a fourth control signal to the signal transmission apparatus through the UC channel according to the information retrieved from the message.

20. A transmission method for use in a signal forwarding apparatus of a multi-hop wireless network, the multi-hop wireless network including a central control apparatus and a signal transmission apparatus, the central control apparatus being configured to build a UC channel between the central control apparatus, the signal transmission apparatus and the signal forwarding apparatus, and transmit a message about the UC channel, the signal transmission apparatus intending to transmit a first control signal to the central control apparatus, the transmission method comprising the following steps of:
receiving the first control signal;
receiving the message about the UC channel;
determining that the UC channel has been built between the central control apparatus, the signal transmission apparatus and the signal forwarding apparatus according to the message;
retrieving information, relating to the UC channel, from the message; and
transmitting the first control signal to the central control apparatus through the UC channel according to the information retrieved from the message.

21. The transmission method as claimed in claim 20, wherein the multi-hop wireless network includes another signal forwarding apparatus, the transmitting step is a step of transmitting the first control signal to the central control apparatus via the another signal forwarding apparatus through the UC channel according to the information retrieved from the message.

22. The transmission method as claimed in claim 20, wherein when the central control apparatus intends to transmit a second control signal to the signal transmission apparatus, the step of receiving the first control signal is a step of receiving the second control signal, the transmitting step is a step of transmitting the second control signal to the signal transmission apparatus through the UC channel according to the information retrieved from the message.

23. The transmission method as claimed in claim 22, wherein the multi-hop wireless network includes another signal forwarding apparatus, the transmitting step is a step of transmitting the second control signal to the signal transmission apparatus via the another signal forwarding apparatus through the UC channel according to the information retrieved from the message.

24. The transmission method as claimed in claim 20, further comprising a step of transmitting a third control signal to the central control apparatus through the UC channel according to the information retrieved from the message.

25. The transmission method as claimed in claim 20, further comprising a step of transmitting a fourth control signal to the signal transmission apparatus through the UC channel according to the information retrieved from the message.
